(19) United States
(12) Patent Application Publication
(10) Pub. No.: US 2013/0340933 A1
(43) Pub. Date: Dec. 26, 2013

(54) METHOD TO MAKE A BALLISTIC MATERIAL

(71) Applicants: Robert Scott Stover, Tempe, AZ (US); Paul Merriman, Houston, TX (US)

(72) Inventors: Robert Scott Stover, Tempe, AZ (US); Paul Merriman, Houston, TX (US)

(73) Assignee: HISCO, INC., Houston, TX (US)

(21) Appl. No.: 11/737,564

(22) Filed: Apr. 19, 2007

(51) Int. Cl. F41H 1/02; F41H 5/04; B32B 37/02

(52) U.S. Cl. CPC F41H 1/02; B32B 37/02; F41H 5/0478
USPC 156/250; 89/36.02; 89/36.05

(57) ABSTRACT

A method for making a ballistic material resistant to penetration from bullet, shrapnel, debris, and other lethal missiles that includes dying a flexible conformable low surface energy fabric having a first thickness; coating a surface of the dyed fabric with an acrylic based adhesive; covering the coated fabric with a liner; cutting the coated lined fabric; printing the cut lined fabric with a fast drying acrylic ink forming a ballistic material having a second thickness up to 300% larger than the first thickness which is tough, resistant to bullet penetration from a range of six feet from the fabric; and cutting the ballistic material into a desired shape.

### FIELD

The present embodiments relate to a method for making a fabric usable for external body armor that protects policemen, soldiers, and others that might experience injury due to fragmentation from explosives or other materials, or might experience a bullet or firearm-related injury.

### BACKGROUND

A need exists for a method for making a ballistic material capable of faster production than currently available techniques that provides a high quality material and consistent results.

A need exists for a method for making a ballistic material or fabric using an adhesive having a very fast cure time.

A need exists for a method for making a ballistic material that can be used as a spall cover for personal wearable body armor and for military vehicle and aircraft seating.

A need exists for a method for making a ballistic material that can be used for tents, covers, and tarps that is strong, usable with other substrates, and can be effective to prevent flying debris from reaching inhabitants of a structure.

A need exists for a method for making a ballistic material that can be used for wind power turbines and solar panel backing, in addition to armor plate covers for personal body armor, fighter pilot seating, helicopter seating, and vehicle seating, including military vehicle and aircraft seating.

The present embodiments meet these needs.

### DETAILED DESCRIPTION OF THE EMBODIMENTS

Before explaining the present embodiments in detail, it is to be understood that the embodiments are not limited to the particular embodiments and that they can be practiced or carried out in various ways.

The present invention relates to a method for making a ballistic material. The present invention further relates to a method for making one or more components of external body armor, such as a side piece or a breast plate of external body armor used by police, Marines, and by other soldiers, made using the ballistic material. The ballistic material can prevent injury caused by fragmentation of the component of body armor, such as when the body armor is impacted by a bullet, shrapnel, debris, or force from an explosive device.

The present method can produce a fabric that is a suitable ballistic material that meets the National Institute of Justice Threat Level IIa, National Institute of Justice Threat Level II, national Institute of Justice threat level IIIA, National Institute of Justice Threat level III, and National Institute of Justice Threat level IV.

One advantage of the present method is that produced ballistic material can be used with a substrate to create a personal body armor component, which enables a completed body armor component to be assembled very quickly, in less than one minute, without requiring equipment such as adhesive dispensers, ovens, and ventilation. No solvents or heated platens are needed to press the parts together, enabling fast assembly of the body armor in factories and the field.

The present method provides a ballistic material that can be applied to any substrate that bonds flexible materials that are used as spall covers for body armor. The training and the ramp up time for assembly of body armor using this processed fabric is very short, nearly instantaneous, and no more than five minutes. Spall covers can also be used to cover and protect military vehicle and aircraft seating.

The present method enables assembly of the body armor or resultant products using the ballistic material without requiring mixing, curing, or heating.

The present method provides a ballistic material wherein the creation of scrap is minimized during assembly of personal body armor and other products. This provides reduced costs in the assembly of personal body armor and other products, as the ballistic material made by this process is a fabric, which is die cut friendly, having a printable top side and edges that burn and seal cleanly—a unique combination of features.

The present invention can combine the elimination of scrap, ease of assembly, and lower insurance cost by offering an automated method for making the ballistic material.

The present method creates a ballistic material by first dying a flexible conformable low surface energy fabric having a first thickness of at least three mils, thereby forming a dyed fabric. The dyed fabric is coated with an acrylic based adhesive, thereby forming a coated fabric. The coated fabric is then covered with a liner, forming a coated lined fabric. The coated lined fabric is then cut, thereby forming a cut lined fabric. The cut lined fabric is printed with a fast drying acrylic ink, forming a ballistic material that is up to 300% thicker than the original flexible conformable low surface energy fabric.

The resulting ballistic material can be cut into any desired shape.

It is contemplated that various fabrics can be used, including polyamides such as nylon, polypropylene, polyethylene or copolymers thereof, such as 70/30 polypropylene-polyethylene blends to 30-70 polypropylene/polyethylene blends. Usable fibers include those known as Twaron™ and microfilaments, such as Dyneema™ available from Allied Signal Company.

The present method can use a flat fabric or a textured fabric, which can be air textured.

In a contemplated embodiment, the present method can include forming a ballistic material comprising an additional urethane coating.

The present method forms a fabric using a high performance acrylic based adhesive to aggressively bond to flexible conformable low surface energy fabrics, such as those listed above. The combined components provide a long-lasting fabric with enhanced chemical resistance and increased stability against ultraviolet degradation. The resultant processed fabric can be cut with die cutters or laser cutters, formed into rolls for easy handling, and possesses good quality, while remaining inexpensive to produce.

The present method contemplates making a processed fabric having an easy release liner that can support printing for component tracking and printing to provide proper alignment of the liner with the fabric.

The present method creates a ballistic material that can be used to cover wind turbine backings, tents, and other military fabric based protection devices and structures. It is contemplated that the ballistic material could be used to cover other objects, and even act as a screen-like device to inhibit bullet penetration through a window at a military campsite, or to prevent hurricane debris from breaking frangible structures on residences and commercial buildings.

The method contemplates, as a first step, dyeing a flexible conformable low surface energy fabric, such as those described previously, creating a dyed fabric. The dyed fabric can be dyed any color, such as military green, sand colored, or bright orange.

It is contemplated that the dyed fabric can have a thickness of at least a three mils, but can range in thickness from one mil to 1000 mils. The thickness can be varied as needed for the particular application of the fabric.

It is further contemplated that the flexible conformable low surface energy fabric can be a polyamide, such as a woven or non woven Nylon™, or another low surface energy (LSE) fabric such as canvas, cotton, polyester or blends of polymer fabrics like the polypropylene, and polyethylene previously mentioned. For example, a woven or non-woven polyamide fabric, known as Nylon™ made by various suppliers using fibers from DuPont of Wilmington, Del. could be used. A Cordura nylon™ is a usable fabric for use in the method. Parachute like material could be used in an embodiment.

In an embodiment, a very thick fabric could be used as a portable tent or portable camp cover, whereas a less thick material could be used for application to a sandwiched or layered hard body armor component, made from fiberglass or a composite of ceramic made by one of a variety of companies, such as Cerco from Ohio or Ortech of Texas, or another tough, lightweight, bullet resistant material, such as a graphite composite. It is contemplated that the ballistic material could be applied to a portion of a building, such as by covering a window to prevent damage and injury caused by fragmentation of the window due to bullets, explosives, debris, and inclement weather.

If the fabric is a woven fabric, it is contemplated that a usable woven fabric would have a denier ranging from 400 to 1000 denier. An example of a usable 500 denier woven Nylon is 500×500 denier textured nylon.

In an embodiment, the fabric is air textured on at least one side. Air texturing enhances adhesion, appearance, and provides some additional thickness to the fabric. Air texturing is typically created by roughing the surface of the fabric using abrasion.

Next, the dyed fabric can be coated using an acrylic based adhesive on either side forming a dyed, coated fabric. The acrylic based adhesive is uniquely useful, because the acrylic adhesive is a pressure sensitive adhesive, retains its elasticity throughout the assembly process, and does not dry hard during assembly of the fabric on a substrate, or between substrate layers. An acrylic adhesive called SCAPA UP2040, made by SCAPA of Connecticut, is contemplated to be particularly useful within the scope of the invention. Cold adhesive can be directly cast on a film. Alternatively, a film can be cast onto a liner, or the adhesive can be made into cast rolls of adhesive, such as SCAPA Unifilm UP2040, for application to the fabric.

It is also contemplated that an additive can be mixed into the acrylic adhesive prior to application to the fabric, such as a flame retardant. For example, Nomex, made by DuPont of Delaware could be added in amounts ranging from 0.1% to 25% by weight of the adhesive.

Other additives can also be mixed into the adhesive, such as fillers, to lower the cost of the manufacturing process, including talc, which can be added in amounts ranging from 0.2% and 15% by weight of the total adhesive formulation.

Still other components, such as antioxidants, flexibility enhancers, plasticizers, and combinations thereof can be added to the adhesive formulation. It is contemplated that these additives can be added in amounts ranging from 0.1% and 5% by weight of the total adhesive formulation.

In an embodiment, the acrylic based adhesive can be clear, enabling inspection of the fabric for tears or holes, which can help to ensure the safety of an armored soldier. It is important to use to ensure that the fabric has at least 98% integrity, and lacks rips, tears, or holes. An exemplary clear acrylic is P-1076 available from SCAPA.

In another embodiment, the adhesive can be white or colored, such as bright orange, so that the adhesive layer can be inspected to ensure that a continuous layer, having 100% coverage, is used on the fabric. The adhesive layer can also help retard of a bullet's travel through the fabric, better protecting soldiers, law enforcement officials, and others.

If pigment is used, it is contemplated that up to 10% by weight of the adhesive formulation can include pigment.

The acrylic adhesive in an embodiment can be spread on the fabric in a thickness ranging from one mil to ten mils, preferably about three mils for sufficient adhesion.

In yet another embodiment, it is contemplated that two different acrylic adhesives could be used, a first applied to the fabric and a second having a slightly different composition applied to the first acrylic adhesive, to provide two different physical property characteristics to the material. For example, one adhesive could aid removal of the subsequently applied liner, while the other provides additional flexibility to the ballistic material. For example, a second adhesive can contain a small amount of urethane, such as up to 10% by weight.

In the next step of the present method, a liner can be placed over the acrylic based adhesive forming a coated, lined fabric. It is contemplated that the coated, lined fabric has a liner that is the same shape as the coated fabric, having an identical length and width to that of the dyed, coated fabric. In another embodiment, however, the liner could extend beyond the fabric.

The liner can be made from a number of materials, including a polyester film, such as Mylar or polyethylene terpthalate, available from DuPont, a coated paper, such as coated Kraft paper, available from Enterprise of Illinois, another polymer film, such as a polypropylene, a polyethylene film, or a polypropylene-polyethylene copolymer film. The liner should have sufficient crystallinity to ensure a level of stiffness for easy removal, but enough flexibility that the liner can be wound when the fabric is wound into bolts or rolls for ease of use during the manufacturing process. It is contemplated that a liner having a thickness of two mils can be used, but the thickness can range from one mil to twenty mils, depending on the fabric being lined.

In an embodiment, the entire method is contemplated for use with an automated, generally computer driven process, wherein fabric is unwound from spools or bolts of fabric on a machine at a rate ranging from 100 to 1000 feet per minute, while the adhesive is cast or rolled on the fabric automatically. After the adhesive is applied, the fabric and the liner, which can be extruded from an extruder if it is a polymer or unwound from bolts of paper if it is paper, can be introduced to nip rollers and moved at the same speed as the fabric, disposing the liner on the fabric while matching the exact size and shape of the fabric. The combination of fabric with adhesive and liner can then be rolled into rolls of any size, such as 3000 feet.

If the liner is kraft paper, it can be a polycoated kraft paper, which has a polymer coating ranging from about one mil to five mils. Alternatively, the liner can be a transparent film having a thickness ranging from 0.5 mils to four mils, permitting visual inspection of the adhesive side of the fabric layer for quality control. The liner can be made from a polyethylene terpthalate, providing a thin, clear, or substantially transparent film, such as 90% transparent.

In an alternative embodiment, a “crack-and-peel” feature can be cut into the liner, enabling rapid removal of the liner when the finished ballistic material is applied to a substrate. The creation of a “crack-and-peel” feature includes cutting a scored or continuous incision in the liner without cutting or penetrating the fabric.

The “crack-and-peel” feature can be formed by using a blade to score the liner. As the liner moves over the blade, a long continuous cut can be made in the liner. This can be part of the computer driven automated process. A die can be used to cut the liner, such as a Heat Treated model from Avis Roto Die of Los Angeles or a die cutter made by Mark Andy of Missouri.

For example, if the fabric is being run through an automated roller process, an underscore die can be attached along the fabric's path, enabling cutting of the liner as the fabric passes. It is contemplated that this part of the method can be automated, such as by using one or more processors in communication with a network to control the creation of the “crack-and-peel” feature.

It is possible that the die cutter could be moved vertically, intermittently contacting the liner. It is important that during the automated process, the blade of the underscore die is positioned to cut only the liner without penetrating the fabric.

It is contemplated that the process can be implemented using a main processor, such as one in a server connected to a network. The network can be the Internet, a cellular network, another wireless network, a fiber optic network, a local area network, a wide area network, or a similar network. It is contemplated that from a client device, such as a personal digital assistant, a cellular telephone, a computer, including a laptop, or other devices, instructions can be communicated from an operator or other user via the network to one or more processors controlling the automated machines. Each machine can have an individual processor that communicates via the network to the main processor. The main processor for running the automated machinery can communicate with main data storage containing computer instructions that enable the entire method to be an automated sequential method, wherein each of the pieces of machinery used in the process is connected together on the network to which the main processor is connected. This can allow a user to quickly and easily operate the entire set of machines from a single personal digital assistant, cellular telephone, or remote computer, from a safe location, while enabling the ballistic material to be created.

It is contemplated that the present method can enable the production of the ballistic material at a rate of at least 100 feet per minute. Another embodiment contemplates a very fast production rate of lined ballistic material, at a rate ranging from about 100 feet to about 1000 feet per minute.

After lining the fabric, the fabric can then be cut into bolts or rolls, which can then be cut into one or more desired roll sizes.

In the next step of the present method, the lined fabric can be printed with a fast drying acrylic ink. The printing can be by a continuous inline printing process or a batch process.

In a contemplated embodiment, the cutting of the fabric and the printing of the fabric can be performed simultaneously.

After printing, the fabric can be cut into a ballistic material up to 300% thicker than the original flexible conformable low energy fabric.

The fabric, after dying, coating, lining, and printing is a flexible ballistic material that is easy to apply to a base substrate, such as a body armor component made from fiberglass, graphite composite, similar materials, or to open cell foam padding disposed on either side of the hard, bullet resistant impenetrable substrate. This allows for the creation of a component of padded, water resistant body armor that is comfortable to wear, but tough and durable in a corrosive environment. It is contemplated that ballistic material produced using the present method can be used in the presence of sand, such as in the desert, or in the presence of high velocity flying particles or similar rough materials, such as a soldier moving against a wall or rough jagged metal, without tearing, and without gouging or disintegrating the ballistic material.

In another embodiment, the step of printing can include depositing a bar code, a serial number, or combinations thereof on the fabric, either by printing, by adhering, or by pressure application. A radio frequency identification tag (RFID) can also be deposited on the fabric.

The serial numbers, bar codes, RFID tags, and combinations of these tracking devices can be placed on the lined fabric for ease of tracking the resultant ballistic material during transit, within three meters, continuously using additional global positioning and other tracking devices.

The printing can be performed using one or more types of acrylic inks, including a solvent based ink, such as WA-14450 made by Wikoff of Kansas. It is also contemplated that an aqueous based ink or an ultraviolet ink can be used.

It is contemplated that the printing of the cut and lined fabric can be done using an inline printing process such as a flexoprinting process that utilizes a drum which is coated and covered by a screen mesh. Fabric is fed past the coated drum and mesh, which contacts the fabric, and the fabric is then printed. Flexo printing™ specifically involves a rubber printing plate on a mandrel or similar roll further having a porous screen mesh that pulls the ink through the porous screen and deposits the ink on the surface of the fabric at a rate ranging from 100 to 500 feet per minute, preferably 300-500 feet per minute. A Mark Andy 4150 Flexopress made by Mark Andy of Kansas City, Kans. is contemplated as particularly usable herein.

The printing can be cured with one or more of the following cure techniques: ultraviolet light in the absence of heat, which saves considerably on energy costs, direct heat, or convection heat using moving heated air. This printing step with sequential curing step is contemplated to be used in the process prior to cutting the printed fabric.

This printing is expected to comply with the 1989 American Society for Testing and Materials (ASTM) Standards D 2805, for opacity, D 523, for gloss, D 1729, for color, and D 2369, for solids, as stated in Commercial Item Description A-A-208B.

After printing, the fabric can be cut to shape, which can be done using die cutters, such as a Mark Andy 4120, or by laser cutting, such as by using a PCMC laser or a ruby laser, or combinations thereof.

To create a spall cover using ballistic material produced using the present method, an oversized front piece of fabric can be applied to a front side of a first open cell foam and wrapped over a substrate's side to cover a portion of a back side of a second open cell foam, then smoothed out. The fabric edge will overlap in the back, then a back piece can be applied on top of the front wrapped edge, creating a smooth finish. The fabric can then be heat sealed with a torch, a laser, a soldering iron, a soldering wire, or Toman™ heat staking equipment, creating a seamless edge forming a spall plate.

The spall cover produced using the present method can have a shelf life of at least one year or more from the date of shipment, if stored in a cool dry place below 76 degrees Fahrenheit. A spall cover produced using the present method can help to prevent injury to soldiers due to fragmentation of body armor components upon impact. The present spall cover can further be used to cover and protect military vehicle and aircraft seating.

In yet another embodiment, it is contemplated to include the step of applying a urethane coating to a surface of the flexible conformable fabric. This additional urethane coating can be a thin coating of fast drying polyurethane, such as having a thickness ranging from one mil to three mils, that can dry almost as quickly as it is applied. The coating can be applied to the fabric after dyeing. An exemplary polyurethane coating can be a polyurethante coating available from Amerabelle, and can be used for water proofing the fabric. It is possible that the urethane coating can be sprayed on the fabric in an amount equivalent to about 0.5 oz to about 0.75 oz per square yard of fabric.

It should be noted that the invention does not require the urethane in all embodiments, and some embodiments without the urethane can be at least 20% less expensive to make than the embodiments that include a urethane coating.

In a particular embodiment of the invention, the method is used to create a ballistic material having a total thickness of 19 mils, which includes an adhesive thickness of 2 mils, a fabric thickness of 15 mils, and a liner thickness of 2 mils. This embodiment can use a clear adhesive which passes a peel adhesive test using PSTC method #101 of Illinois—at 180 degrees initial to SS (20 min @RT) which yields at 32 inches per ounce and a holding power using PST Method #107 at 178 degrees of 23.2 PSI (1 inch×1 inch×1000 g) at RT, which was greater than 24 hours.

Additionally, it is contemplated that one or more components of outer body armor can be created by using the ballistic material made using the present method. The ballistic material can be disposed over a base structure of a substrate, such as a ceramic, a fiberglass, other durable crystalline polymers, or a graphite composite can be created and sandwiched between two foam layers made from different materials. The two foam layers can include a soft layer to contact with a soldier's body and an outer layer to support deflection of bullets and resist impacts of blunt instruments, such as rocks, rifle butts, shrapnel, debris, or fists of militant people.

It is contemplated that the ballistic material, once applied to the substrate and foam combination, can be sealed, such as heat sealed with a torch, to prevent water or other materials from entering through seams in the fabric.

While these embodiments have been described with emphasis on the embodiments, it should be understood that within the scope of the appended claims, the embodiments might be practiced other than as specifically described herein.

1. A method for making a ballistic material covering resistant to penetration from bullets, shrapnel, debris, and other lethal missiles, comprising:
dying a flexible conformable low surface energy fabric having a first thickness of at least three mils forming a dyed fabric, wherein the flexible conformable low surface energy fabric is a ballistic material;
coating a surface of the dyed fabric with an acrylic based adhesive forming a coated fabric, wherein the acrylic base adhesive is cold when applied to the dyed fabric;
covering the coated fabric with a liner forming a coated lined fabric;
cutting the coated lined fabric into at least one desired size forming a cut lined fabric;
printing the cut lined fabric with a fast drying acrylic ink forming the ballistic material covering, wherein the liner is configured to be removed from the ballistic material covering to allow the ballistic material covering to be attached to a base substrate; and
cutting the ballistic material covering into a desired shape.

2. The method of claim 1, wherein the method for making the ballistic material covering is a continuous process.

3. The method of claim 1, wherein the printing further includes depositing a member of the group consisting of: a bar code, a radio frequency identification tag, a serial number, or combinations thereof, on the cut and lined fabric for tracking the ballistic material covering.

4. The method of claim 1, wherein the fast drying acrylic ink is a solvent based ink, an aqueous based ink, or an ultraviolet ink.

5. The method of claim 1, wherein the liner and the coated fabric have identical lengths and widths.

6. The method of claim 1, wherein the printing is performed using an inline flexographic printer and the printing is cured using a member of the group: ultraviolet light, direct heat, or convection heat.

7. The method of claim 1, further comprising applying a urethane coating to a surface of the flexible conformable low surface energy fabric.

8. The method of claim 1, wherein the printing of the cut fabric is performed according to the 1989 American Society for Testing and Materials Standards D 2805, D 523, D 1729, and D 2369.

9. The method of claim 1, wherein the acrylic based adhesive is clear.

10. The method of claim 1, wherein the cutting is die cutting, laser cutting, or combinations thereof.

11. The method of claim 1, wherein the flexible conformable low surface energy fabric is a nylon, a canvas, a cotton, a polyester, a polypropylene, a polyethylene, and copolymers thereof.

12. The method of claim 1, wherein the liner is polycoated kraft paper.

13. The method of claim 1, wherein the liner is transparent.

14. The method of claim 1, wherein the liner comprises a polyethylene terphthalate liner or a polymer film.

15. The method of claim 1, further comprising creating a “crack-and-peel” feature in the liner for ease of removal of the liner from the ballistic material covering.

16. The method of claim 1, wherein the flexible conformable low surface energy fabric is air textured.

17. The method of claim 1 wherein the flexible conformable low surface energy fabric has a thickness ranging from three mils to ten mils.

18. The method of claim 1, wherein the flexible conformable low surface energy fabric is a woven fabric with 400 to 1000 denier.

19. The method of claim 1, further comprising blending a flame retardant into the acrylic based adhesive prior to applying the acrylic based adhesive.

20. (canceled)

21. (canceled)

22. (canceled)
